(19) United States
(12) Patent Application Publication
(10) Pub. No.: US 2021/0150389 A1
(43) Pub. Date: May 20, 2021

(54) INFERENCE SYSTEM, INFERENCE DEVICE, AND INFERENCE METHOD

(71) Applicant: AXELL CORPORATION, Tokyo (JP)

(72) Inventor: Kazuki KYAKUNO, Tokyo (JP)

(73) Assignee: AXELL CORPORATION, Tokyo (JP)

(21) Appl. No.: 17/097,926

(22) Filed: Nov. 13, 2020

(30) Foreign Application Priority Data
Nov. 14, 2019 (JP) 2019-206312

(51) Int. Cl. G06N 5/04; G06N 3/08; G06F 9/445; G06F 9/30

(52) U.S. Cl. CPC G06N 5/04; G06F 9/30025; G06F 9/445; G06N 3/08

(57) ABSTRACT

An inference system includes a first device and a second device. The first device includes a first processor which executes the following processing. The first processor loads a learned model created by the second device, including first control information for causing the first device to perform postprocessing. The first processor accepts input of input data of a neural network, which is an object of an inference process. The first processor executes the inference process on the input data by using the learned model. The first processor performs the postprocessing that converts a data format of output data output as a result of the inference process to a format corresponding to subsequent processing in accordance with the first control information included in the learned model. The second device includes a second processor which performs the following processing. The second processor creates the learned model including the first control information.

### CROSS-REFERENCE TO RELATED APPLICATIONS

This application is based upon and claims the benefit of priority of the prior Japanese Patent Application No. 2019-206312, filed on Nov. 14, 2019, the entire contents of which are incorporated herein by reference.

### FIELD

The embodiments discussed herein are related to an inference system, an inference device, and an inference method.

### BACKGROUND

An inference process using a neural network that includes an input layer, an intermediate layer, and an output layer is used in applications such as image recognition, speech recognition, and character recognition.

In a learning process of a neural network, deep learning is performed by using a configuration including a multi-layered intermediate layer, thereby creating a learned model that can perform inference with high accuracy.

A user of an application executes an inference process by loading a learned model defined by a network structure and weight coefficients into an inference framework executed by an inference device (for example, Japanese Patent Application Laid-open No. 2019-159499).

The format of input data in the inference process is limited in accordance with setting in learning. Examples of the limitation include the number of elements of one piece of data corresponding to the number of input neurons and the resolution of data.

The inference device performs preprocessing that converts the input data to a format appropriate for the above limitation and inputs the preprocessed input data to a neural network.

Further, the inference device performs postprocessing that converts output data of the neural network to a format appropriate for processing performed in a subsequent stage and outputs the postprocessed output data to a subsequent application.

As a relevant art, there are disclosed a preprocessing device that preprocesses learning data supplied to a neural network arithmetic device in learning and a preprocessing device that preprocesses recognition data supplied to the neural network arithmetic device in recognition.

In the preprocessing in learning, it is possible to reduce the number of data sets of learning data input to the neural network arithmetic device to an appropriate number, for example, by binarization, thereby shortening a learning time. Further, in the preprocessing in recognition, it is possible to improve the recognition rate by emphasizing the feature of recognition data, for example, by quantization.

Furthermore, there is also disclosed a postprocessing device that receives an arithmetic result of learning or recognition by the neural network arithmetic device based on the learning data or the recognition data preprocessed by the preprocessing device and performs data conversion (postprocessing) in accordance with a device to be used later (for example, Japanese Patent Application Laid-open No. H8-212182).

A learned model that performs inference using a neural network may be created by a seller that develops an inference system for commercial purposes and be provided to a user of an inference device, instead of being created by the user by himself.

In this case, the user of the inference device purchases and downloads a learned model uploaded on a network by the seller, and uses the learned model by incorporating it into an inference framework introduced in advance into the user's own inference device.

Because the inference framework itself can operate on multiple platforms, the user can easily execute the inference framework in the user's own environment.

However, at present, the user needs to implement the preprocessing device and the postprocessing device in accordance with the user's own environment by using a programming language, for example, the C language or Python.

Such implementation by the user himself is difficult, recompiling is required for each platform, and portability is low.

Consequently, at present, there is a problem that use of a learned model provided by a seller is not easy.

### SUMMARY

According to an aspect of the embodiments, an inference system comprises a first device and a second device. The first device includes a first processor which executes the following processing. The first processor loads a learned model created by the second device, including first control information for causing the first device to perform postprocessing. The first processor accepts input of input data of a neural network, which is an object of an inference process. The first processor executes the inference process on the input data by using the learned model. Further, the first processor performs the postprocessing that converts a data format of output data output as a result of the inference process to a format corresponding to subsequent processing in accordance with the first control information included in the learned model. The second device includes a second processor which executes the following processing. The second processor creates the learned model that includes the first control information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanatory diagram of a method for performing inference using a neural network.

FIG. 2 is an explanatory diagram of an outline of an inference system to which an inference device according to an embodiment of the present invention is applied.

FIG. 3 is an explanatory diagram of an inference process according to a first example.

FIG. 4 is an explanatory diagram of a method of creating a learned model that performs preprocessing and postprocessing by virtual machines in the first example.

FIG. 5 is an explanatory diagram of an inference device according to a second example.

FIG. 6 is a diagram illustrating a method of creating a learned model in which preprocessing and postprocessing are implemented as CNN layers according to a second embodiment.

FIG. 7 is a block diagram for explaining a functional configuration of an inference device according to the first example.

FIG. 8 is a block diagram for explaining a functional configuration of a seller device according to the first example.

FIG. 9 is a block diagram for explaining a functional configuration of the inference device according to the second example.

FIG. 10 is a block diagram for explaining a functional configuration of a seller device in the second example.

FIG. 11 is a flowchart for explaining a learned-model request process executed by the inference device.

FIG. 12 is a flowchart for explaining a learned-model transmission process executed by the seller device in response to the learned-model request process in FIG. 11.

FIG. 13 is a flowchart for explaining an inference process executed by the inference device.

FIG. 14 is a block diagram illustrating an example of a computer device.

### DESCRIPTION OF EMBODIMENTS

An embodiment of the present invention will be described below in detail with reference to the accompanying drawings.

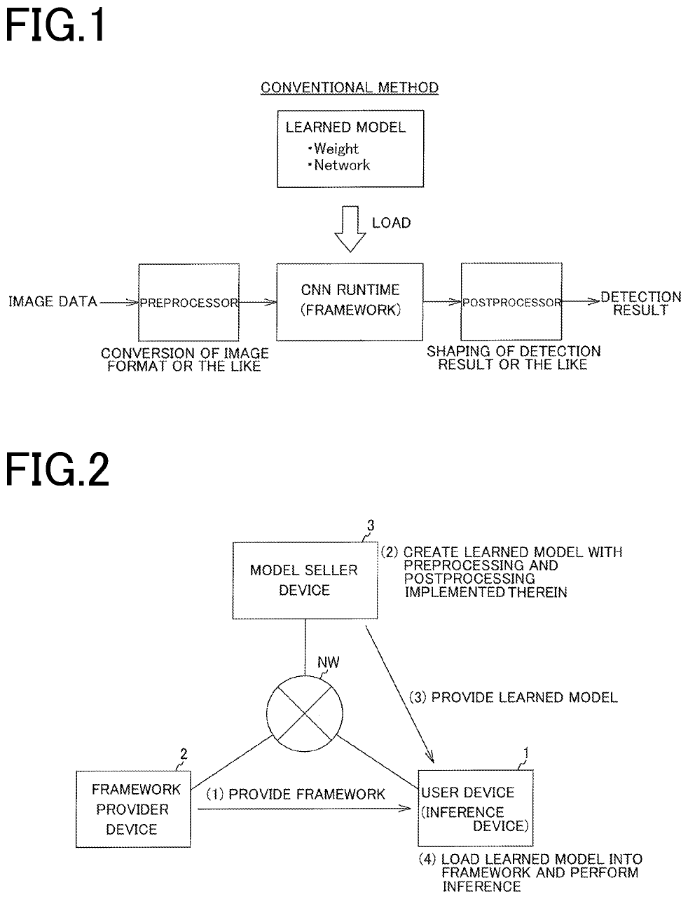

FIG. 1 is an explanatory diagram of a method for performing inference using a neural network.

In inference using a neural network, a learned model is loaded into an inference framework of a CNN (Convolutional Neural Network). The learned model is defined by a network structure and weight coefficients, and the inference framework executes an inference process by using these pieces of information as parameters.

The inference framework is also called an inference runtime. The inference runtime is an abbreviation for an inference runtime library and is a file including a bundle of components of a program used in executing the neural network (a main program).

The inference process by the inference framework requires preprocessing to be performed for image data or the like that is an object of inference before the data is input to the inference framework and postprocessing to be performed for output of the inference framework. A preprocessor and a postprocessor are described by a user in the C language or the like.

Preprocessing is conversion of an image format or the like, and postprocessing is shaping of a detection result or the like.

In “Yolo”, for example, an input 8-bit image is subjected to conversion to float, sorting in the order of RGB, and resizing as preprocessing, and is thereafter supplied to a CNN. Expected input is different depending on the type of a learned model. For example, as the expected input, the range of each of RGB values is −128 to 127, 0 to 1.0, or −0.5 to 0.5. Therefore, preprocessing is performed to adjust the input to the expected input.

There is a case in which an input image is subjected to Fourier transform as preprocessing and is thereafter input to the inference framework, or a case in which calculation of motion vectors between frames is performed as preprocessing and thereafter the input image is input to the inference framework.

Further, in a case of “Yolo” described above, the output of the CNN is a 1470-dimensional vector. As postprocessing, it is necessary to convert the output to a bounding box using a code as described below.

| | |
|---|---|
| probs=cnn_output[0:980].reshape((7,7,20)) | # class probabilities |

| | |
|---|---|
| confs= cnn_output [980:1078].reshape((7,7,2)) | # confidence score |

| | |
|---|---|
| for Bounding Boxes | |
| boxes = cnn_output [1078:].reshape((7,7,2,4)) | # Bounding Boxes |
| positions (x,y,w,h) | |
| for(int by=0;by<7;by++){ | |

for(int bx=0;bx<7;bx++){

for(int box=0;box<2;box++){

for(int category=0;category<20;category**){

if(confs[by][bx][box]*probs[by][bx][category]>0.1f){

x= (bx*boxes[by][bx][box][01)*(448/7);
y = (by*boxes[by][bx][box][1])*(448/7);
w = pow(box[by][bx][box][2],2)*448;
h = pow(box[by][bx][box][3],2)*448;
x1 = x − w/2;
x2 = x + w/2;
y1 = y − h/2;
y2 = y + h/2;
class = classes[category];

}

}

}

}

The inference framework itself operates on multiple platforms.

However, the preprocessor that adjusts the format of input data (target data) input to the inference framework and the postprocessor that shapes an output vector to an expected result (for example, a bounding box) cannot be included in the learned model because they are described in the C++ language or Python, for example.

As for the preprocessor and the postprocessor, a user has to write program codes to realize the processors by himself, which is considerably difficult.

Further, in order to use a learned model on a different platform, recompiling is required for each platform and portability is low. Consequently, it is not easy to use the learned model.

This problem hinders creation of a sales platform of learned models. From a viewpoint of a seller, it is necessary to provide postprocessing as a program, which may result in leak of know-how. From a viewpoint of a user, it is necessary to perform coding of postprocessing, and thus handling is complicated.

In a neural network, learning is performed by using training data when a learned model is created. In update of the learned model, learning is performed by using new training data.

Training data is data of questions and answers for which a label, an offset, and a bounding box, for example, are adjusted to make learning of a neural network easier. Therefore, when the training data is changed, it is also necessary to adjust preprocessing and postprocessing used in inference.

This is because the preprocessor and the postprocessor are created to correspond to an inference framework used in learning, setting in learning, and the like. Further, as the setting in learning, suitable setting is made by an engineer for every piece of input data that corresponds to an object of inference as appropriate. Therefore, the setting in learning is not determined uniquely. The inference framework used in learning may be different from an inference framework used in inference, and thus a plurality of types of setting may be made.

Preprocessing and postprocessing are different between learned models.

It is difficult to apply a preprocessing program or a postprocessing program which is created once to an updated learned model, and it is necessary to perform coding of preprocessing or postprocessing again also when the learned model is updated. Accordingly, handling becomes complicated especially for a user.

When it is considered that a learned model is replaced while the preprocessing program or the postprocessing program is left as it is, the range in which replacement can be performed becomes narrower especially in a case where postprocessing is hard-coded.

An inference device according to the present embodiment and a learned model used by the inference device solve these problems.

Functions of preprocessing and postprocessing are incorporated into a learned model in advance, and the functions are made executable in an inference framework. Accordingly, a user of the learned model does not need to write a code for preprocessing or postprocessing by himself. Consequently, use of the learned model can be made quite easy.

FIG. 2 is an explanatory diagram of an outline of an inference system to which an inference device according to the present embodiment is applied.

The system includes an inference device 1 used by a user of a learned model, an inference-framework provider device 2 used by a provider of an inference framework, and a seller device 3 used by a seller of the learned model, for example, a seller of applications. These devices are connected to a network NW, for example, the Internet and are configured to be communicable with each other.

A processing flow according to the present embodiment is described with reference to FIG. 2.

S1: A provider of an inference framework provides an inference framework as a runtime library in which a VM is incorporated in an inference runtime, to a user. The user of a learned model introduces the provided inference framework into the user's own inference device 1.

S2: A seller of the learned model creates the learned model with functions of preprocessing and postprocessing incorporated therein for the inference framework provided by the provider by using the seller device 3.

S3: The seller of the learned model sells and provides the created learned model to the user by using the seller device 3. The learned model is sold and provided directly to the user from the seller device 3. Alternatively, the learned model uploaded on a server of a learned-model store by the seller may be downloaded by the user by means of the inference device 1 to be provided.

S4: The user of the inference device 1 loads the learned model provided in (3) into the inference framework provided in (1) and executes an inference process on input data or the like by using the inference device 1. Although an inference process using image data is described as an example in the following descriptions, input data may be other data, for example, voice data or character data.

The outline of the inference process in the present embodiment is described, while processing executed by each of the inference device 1 and the seller device 3 will be described in detail later.

The inference device 1 performs preprocessing that executes a function of preprocessing included in a learned model for input data to convert the input data to a format corresponding to an inference process.

The inference device 1 inputs the preprocessed input data to a neural network to perform the inference process.

Further, the inference device 1 performs postprocessing that executes a function of postprocessing included in the learned model for output data (inference-result output data) of the neural network to convert the format of the output data to a format corresponding to subsequent processing. For example, the inference device 1 adapts the format of the output data of the inference process to processing executed in a subsequent application.

The inference device 1 outputs the postprocessed output data to the application executed in a subsequent stage.

The learned model includes the function of preprocessing and the function of postprocessing. Therefore, a user of the inference device 1 can execute the inference process without considering preprocessing and postprocessing for input/output data by purchasing the learned model from the model seller and incorporating the purchased learned model into the inference framework. Therefore, it is possible to easily use the learned model.

Further, because preprocessing and postprocessing can be integrated in the learned model, a consistent cross-platform operation can be achieved.

In a case where the learned model has been updated by relearning, the seller of the learned model can provide the learned model including the functions of preprocessing and postprocessing corresponding to a new learned model. For example, the seller device 3 can upload the new learned model on a server of a model store. The inference device 1 loads the functions of preprocessing and postprocessing included in the newly provided learned model into the framework, and executes the inference process.

In a neural network, learning is performed by using training data when a learned model is created. In update of the learned model, learning is performed by using new training data.

Training data is data of questions and answers for which a label, an offset, and a bounding box, for example, are adjusted to make learning of a neural network easier.

When training data in learning is changed, preprocessing and postprocessing used in inference also need to be adjusted.

Because preprocessing and postprocessing are conventionally implemented by being hard-coded in the inference framework as described above, programs of preprocessing and postprocessing needed to be newly created after update of the learned model.

Therefore, use of the new learned model after update had been complicated.

Meanwhile, according to the present embodiment, the seller of the learned model for which learning process has been executed makes the functions of preprocessing and postprocessing corresponding to the new learned model be included in the learned model itself.

The user can cause the inference device 1 to execute an inference process using the new learned model only by loading the updated learned model into the inference framework. Therefore, use of the learned model becomes easier.

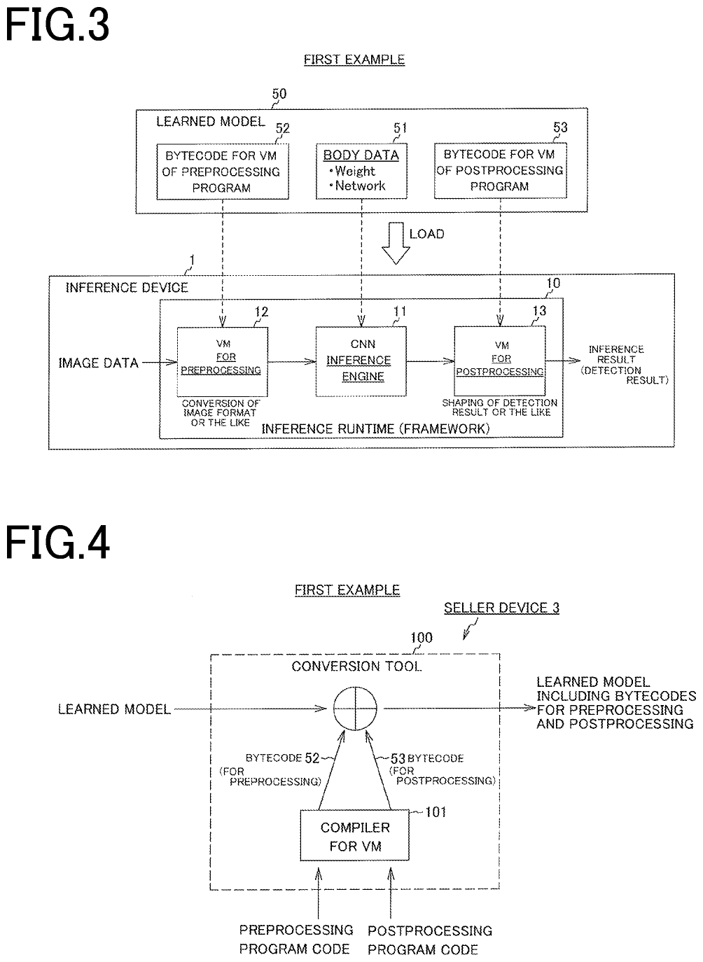

FIG. 3 is an explanatory diagram of an inference process according to a first example.

The inference device 1 executes an inference process by executing an inference framework 10.

In this example, a VM (virtual machine) is incorporated in the inference framework 10, and a learned model is configured to include a bytecode executable by this VM as a function of preprocessing or postprocessing.

The inference framework 10 can perform each of preprocessing and postprocessing by executing the bytecode included in the learned model.

The inference framework 10 includes an inference engine 11, a preprocessing VM 12, and a postprocessing VM 13.

The inference engine 11 executes an inference process by a neural network, for example, a CNN.

The preprocessing VM 12 executes a bytecode for preprocessing to perform preprocessing such as format conversion on data such as an image input to the inference engine 11.

The postprocessing VM 13 executes a bytecode for postprocessing to perform postprocessing for the result of inference by the inference engine 11.

On the other hand, a learned model 50 loaded by the inference framework 10 includes body data 51 of the neural network, such as a network structure and weighting, and a complied bytecode for a VM.

The bytecode for a VM includes a bytecode 52 of a preprocessing program and a bytecode 53 of a postprocessing program.

When image data or the like is input, the inference framework 10 executes the bytecode 52 of a preprocessing program and the bytecode 53 of a postprocessing program included in the learned model 50 by using the preprocessing VM 12 and the postprocessing VM 13, thereby automatically performing preprocessing and postprocessing, respectively.

As a result, a user of the learned model 50 does not need to separately prepare a preprocessing program and a postprocessing program by describing program codes for preprocessing and postprocessing by himself. It can be said that use of the learned model becomes easier.

FIG. 4 is an explanatory diagram of a method of creating a learned model that performs preprocessing and postprocessing by virtual machines in the first example.

A seller of a learned model creates, in the seller device 3, the learned model 50 corresponding to VMs included in an inference framework by using a conversion tool 100 described in FIG. 4.

The conversion tool 100 includes a compiler 101 that generates a bytecode for a VM by compiling a program code for the VM.

The seller inputs the learned model 50 learned in an existing inference framework, a code of a preprocessing program, and a code of a postprocessing program to the conversion tool in the seller device 3 that executes the conversion tool 100.

The conversion tool 100 generates a bytecode by compiling the program code for a VM using a compiler for the VM and makes the generated bytecode be included in the learned model 50.

The bytecode may be packed with the learned model 50 into one file, or the bytecode and the learned model 50 may be distributed as separate files at the same time.

The original know-how that should be kept secret is introduced into both the program code for preprocessing and the program code for postprocessing. Therefore, in order to prevent reverse engineering of the bytecode and leak of the know-how, the bytecode included in the learned model 50 may be distributed while being encrypted.

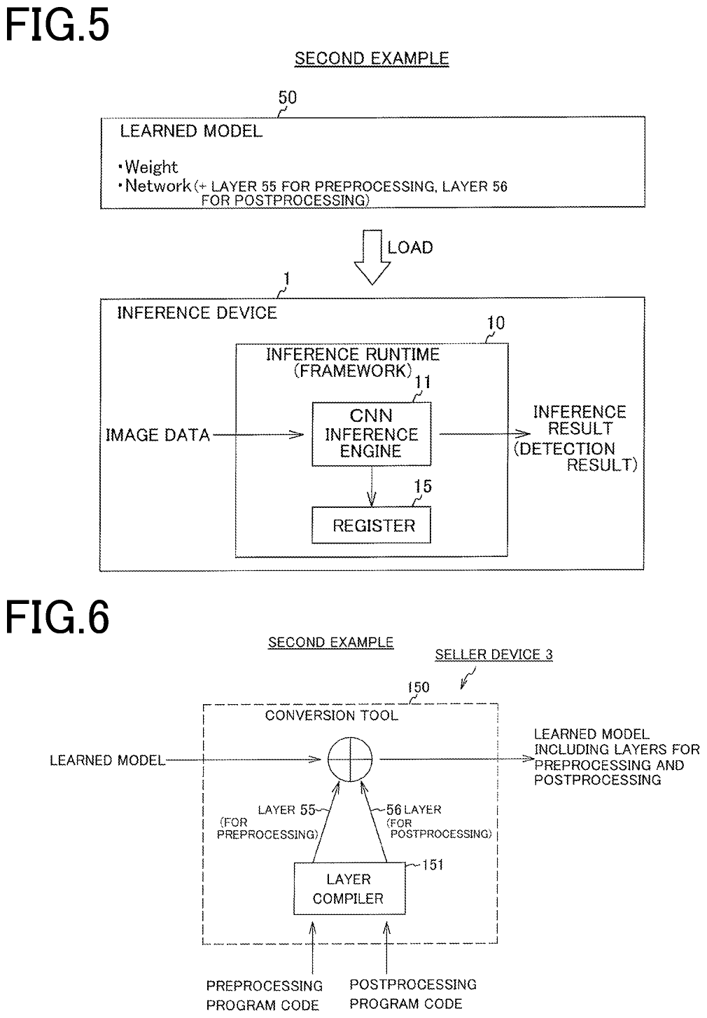

FIG. 5 is an explanatory diagram of an inference device according to a second example.

The inference framework 10 has a function corresponding to a register or a memory. The inference framework 10 implements basic instructions of a VM described in FIGS. 3 and 4 (reading from a register and storing to the register, reading from a memory and storing to the memory, a conditional branch, and a loop) as CNN layers, respectively, and is Turing-complete. The layers have substantially the same architecture as the VMs described in FIG. 3.

The learned model 50 loaded by the inference framework 10 includes weighting and a network structure, and layers corresponding to instructions of the VMs in FIG. 3 on a one-to-one basis are defined in the network structure. These layers perform preprocessing and postprocessing.

This configuration is the same as the configuration in FIG. 3 in that functions of performing preprocessing and postprocessing are included in the learned model 50.

When the learned model 50 including the layer for preprocessing and the layer for postprocessing are loaded into an inference runtime, the inference engine 11 performs preprocessing for image data, an inference process by a CNN, and postprocessing for the inference result.

FIG. 6 is a diagram illustrating a method of creating a learned model in which preprocessing and postprocessing are implemented as CNN layers according to a second embodiment.

A seller of a learned model creates, in the seller device 3, the learned model 50 in which preprocessing and postprocessing are implemented as CNN layers by a conversion tool 150 described in FIG. 6.

The seller of the learned model inputs the learned model 50 that includes a “network structure” and “weighting” learned in an existing inference framework, a code of a preprocessing program, and a code of a postprocessing program to the conversion tool 150 in the seller device 3.

The conversion tool 150 drops (complies) the code of a preprocessing program and the code of a postprocessing program into layers respectively by using a layer compiler 151 and makes generated layers 55 and 56 be included in the learned model 50.

That is, the conversion tool 150 converts the code of a preprocessing program and the code of a postprocessing program to bytecodes in the form of layers, and connects the layers to a neural network before and after the neural network.

“Drop into a layer” means conversion to a layer format that can be processed by a CNN by expanding loop processing or the like included in the program code of a preprocessing program or a postprocessing program.

A program compiled as a layer is stored as a network structure in the learned model 50, and therefore the inference device 1 that loads the learned model 50 thereinto can perform all of preprocessing, an inference process, and postprocessing by a CNN.

As a result, a user of the learned model 50 does not need to separately prepare a preprocessing program and a postprocessing program by describing program codes for preprocessing and postprocessing by himself. Thus, it can be said that use of the learned model becomes easier.

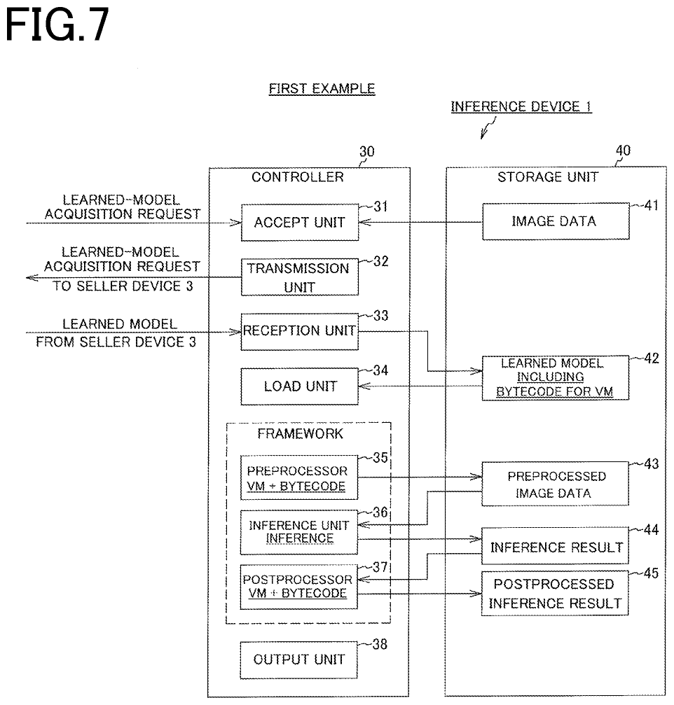

FIG. 7 is a block diagram for explaining a functional configuration of an inference device according to the first example.

The inference device 1 includes a controller 30 and a storage unit 40.

The controller 30 includes an accept unit 31, a transmission unit 32, a reception unit 33, a load unit 34, a preprocessor 35, an inference unit 36, a postprocessor 37, and an output unit 38.

The storage unit 40 includes an image-data storage unit 41, a learned-model storage unit 42, a preprocessed-image-data storage unit 43, an inference-result storage unit 44, and a postprocessed-inference-result storage unit 45.

The accept unit 31 accepts input of image data or the like from the image-data storage unit 41 to the inference framework 10. The accept unit 31 also accepts a learned-model acquisition request that requests acquisition of a learned model, from a user.

In response to acceptance of the learned-model acquisition request by the accept unit 31, the transmission unit 32 transmits the learned-model acquisition request to the seller device 3. The transmission unit 32 also transmits the image data or the like, input to and accepted by the accept unit 31, to the seller device 3.

The reception unit 33 receives a learned model from the seller device 3 and stores it in the learned-model storage unit 42.

The load unit 34 loads the learned model from the learned-model storage unit 42 and incorporates it into the inference framework 10.

The preprocessor 35 corresponds to the preprocessing VM 12 and executes the bytecode 52 for preprocessing included in the loaded learned model 50. Accordingly, the preprocessor 35 preprocesses the image data or the like and stores the preprocessed image data or the like in the preprocessed-image-data storage unit 43.

Preprocessing is processing that converts image data to an image format corresponding to an inference process, as described above.

The inference unit 36 corresponds to the inference engine 11. The inference unit 36 executes an inference process on the preprocessed image data stored in the preprocessed-image-dada storage unit 43 by using body data included in the loaded learned model 50, and stores inference-result output data in the inference-result storage unit 44.

The postprocessor 37 corresponds to the postprocessing VM 13 and executes the bytecode 53 for postprocessing included in the loaded learned model 50. Accordingly, the postprocessor 37 postprocesses the inference-result output data stored in the inference-result storage unit 44, and stores the postprocessed inference-result output data in the postprocessed-inference-result storage unit 45.

Postprocessing is processing that adapts inference-result output data to processing executed in a subsequent application, as described above.

The output unit 38 outputs the postprocessed inference-result output data stored in the postprocessed-inference-result storage unit 45 to the subsequent application.

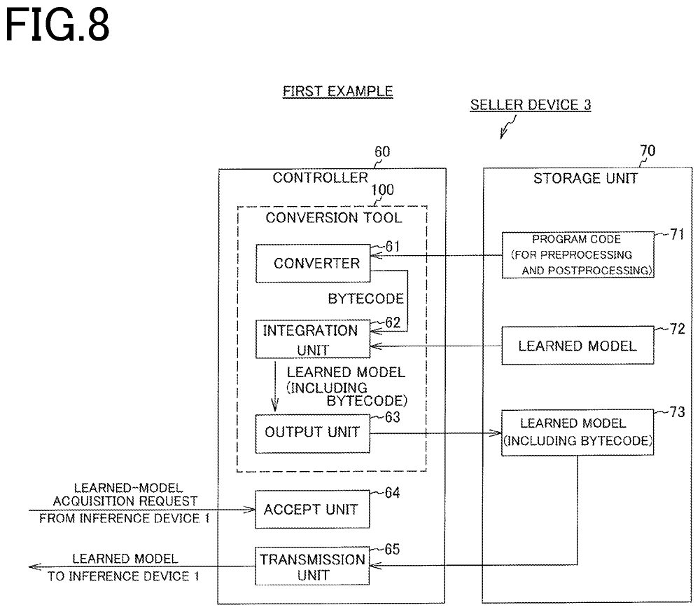

FIG. 8 is a block diagram for explaining a functional configuration of a seller device according to the first example.

The seller device 3 includes a controller 60 and a storage unit 70.

The controller 60 includes a converter 61, an integration unit 62, an output unit 63, an accept unit 64, and a transmission unit 65.

The storage unit 70 includes a program-code storage unit 71, a learned-model storage unit 72, and an integrated-learned-model storage unit 73.

The program-code storage unit 71 stores therein program codes of a preprocessing program and a postprocessing program which have been prepared in advance.

The learned-model storage unit 72 stores therein a learned model that has been learned in advance.

The integrated-learned-model storage unit 73 stores therein an integrated learned model with functions of preprocessing and postprocessing integrated therewith.

The converter 61 converts (compiles) the program code for each of preprocessing and postprocessing input from the program-code storage unit 71 to a bytecode for a VM. The converter 61 corresponds to the compiler 101 in FIG. 4. The converter 61 may encrypt the bytecode in this process.

The integration unit 62 incorporates the bytecode obtained by conversion by the converter 61 into the learned model 50 stored in the learned-model storage unit 72 to integrate the bytecode with the learned model 50. The integration unit 62 may encrypt the bytecode in this process.

The output unit 63 outputs the learned model 50 with the bytecode integrated therewith to the integrated-learned-model storage unit 73.

The accept unit 64 accepts a learned-model acquisition request from the inference device 1.

The transmission unit 65 transmits the learned model with the bytecode incorporated therein stored in the integrated-learned-model storage unit 73 to the inference device 1.

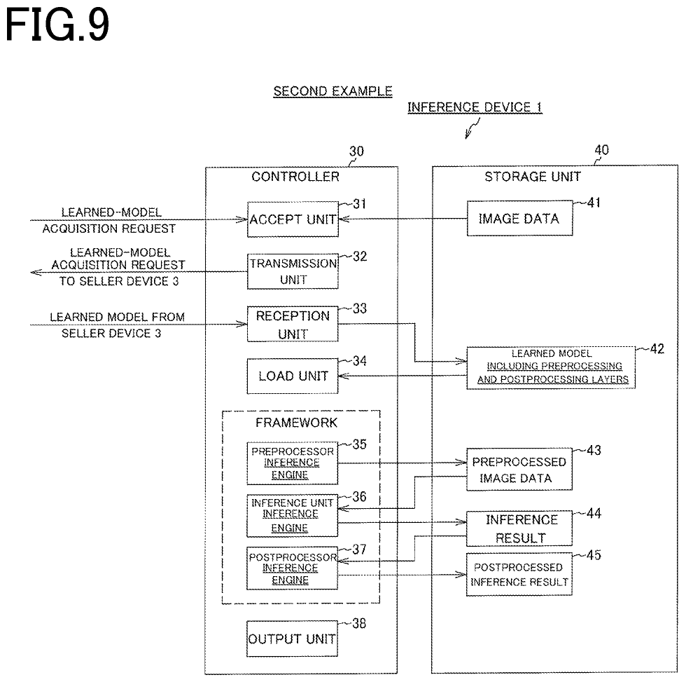

FIG. 9 is a block diagram for explaining a functional configuration of an inference device according to the second example. Configurations identical to those in FIG. 7 are described while being denoted by like reference signs.

The inference device 1 includes the controller 30 and the storage unit 40, similarly to the first example.

The controller 30 includes the accept unit 31, the transmission unit 32, the reception unit 33, the load unit 34, the preprocessor 35, the inference unit 36, the postprocessor 37, and the output unit 38.

The storage unit 40 includes the image-data storage unit 41, the learned-model storage unit 42, the preprocessed-image-data storage unit 43, the inference-result storage unit 44, and the postprocessed-inference-result storage unit 45.

The accept unit 31 accepts input of image data or the like from the image-data storage unit 41 to the inference framework 10. The accept unit 31 also accepts a learned-model acquisition request from a user.

In response to acceptance of the learned-model acquisition request by the accept unit 31, the transmission unit 32 transmits the learned-model acquisition request to the seller device 3. The transmission unit 32 also transmits the image data, input to and accepted by the accept unit 31, to the seller device 3.

The reception unit 33 receives a learned model from the seller device 3 and stores it in the learned-model storage unit 42.

The load unit 34 loads the learned model from the learned-model storage unit 42 and incorporates it into the inference framework 10.

The preprocessor 35 corresponds to the inference engine 11 and executes the layer 55 for preprocessing included in the loaded learned model 50. Accordingly, the preprocessor 35 performs preprocessing for the image data or the like and stores the preprocessed image data or the like in the preprocessed-image-data storage unit 43.

Preprocessing is processing that, for example, converts image data to an image format corresponding to an inference process, as described above.

The inference unit 36 corresponds to the inference engine 11. The inference unit 36 executes an inference process on the preprocessed image data stored in the preprocessed-image-dada storage unit 43 by using the body data 51 included in the loaded learned model 50, and stores inference-result output data in the inference-result storage unit 44.

The postprocessor 37 corresponds to the postprocessing VM 13 and executes the layer 56 for postprocessing included in the loaded learned model 50. Accordingly, the postprocessor 37 postprocesses the inference-result output data stored in the inference-result storage unit 44, and stores the postprocessed inference-result output data in the postprocessed-inference-result storage unit 45.

Postprocessing is processing that, for example, adapts inference-result output data to processing executed in a subsequent application, as described above.

The output unit 38 outputs the postprocessed inference-result output data stored in the postprocessed-inference-result storage unit 45 to the subsequent application.

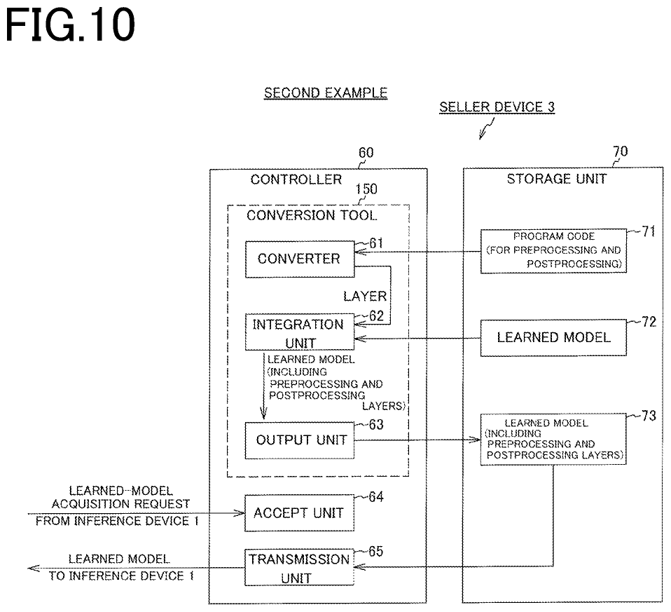

FIG. 10 is a block diagram for explaining a functional configuration of a seller device in the second example. Configurations identical to those in FIG. 8 are described while being denoted by like reference signs.

The seller device 3 includes the controller 60 and the storage unit 70, similarly to the first example.

The controller 60 includes the converter 61, the integration unit 62, the output unit 63, the accept unit 64, and the transmission unit 65.

The storage unit 70 includes the program-code storage unit 71, the learned-model storage unit 72, and the integrated-learned-model storage unit 73.

The program-code storage unit 71 stores therein program codes of a preprocessing program and a postprocessing program which have been prepared in advance.

The learned-model storage unit 72 stores therein a learned model that has been learned in advance.

The integrated-learned-model storage unit 73 stores therein an integrated learned model with functions of preprocessing and postprocessing integrated therewith.

The converter 61 expands the program code of each of preprocessing and postprocessing input from the program-code storage unit 71 and converts (compiles) it into a layer. The converter 61 corresponds to the layer compiler 151 in FIG. 6.

The integration unit 62 incorporates the layer obtained by conversion by the converter 61 into the learned model 50 stored in the learned-model storage unit 72 to integrate the layer with the learned model 50.

The output unit 63 outputs the learned model 50 with the layer integrated therewith to the integrated-learned-model storage unit 73.

The accept unit 64 accepts a learned-model acquisition request from the inference device 1.

The transmission unit 65 transmits the learned model with the layer incorporated therein stored in the integrated-learned-model storage unit 73 to the inference device 1.

A layer compiler may be provided in the inference engine 11 of the inference device 1, not in the conversion tool 150 of the seller device 3.

In this case, the conversion tool 150 only makes the code of the preprocessing program and the code of the postprocessing program be included in the learned model 50.

When the inference engine 11 of the inference device 1 loads the learned model 50 thereinto, the layer compiler expands loop processing or the like included in the preprocessing program code and the postprocessing program code included in the learned model 50, thereby converting the preprocessing program code and the postprocessing program code into bytecodes in the form of layers processable by a CNN.

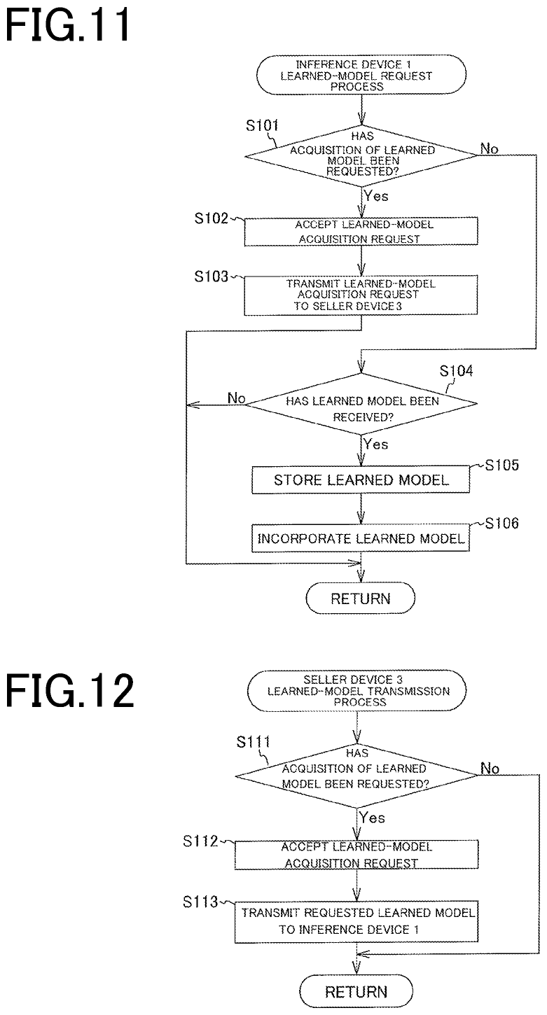

FIG. 11 is a flowchart for explaining a learned-model request process executed by an inference device.

At Step S101, the accept unit 31 determines whether a learned-model acquisition request has been made. The learned-model acquisition request can be made by a user of the inference device 1 by means of an input device such as a keyboard or a mouse provided in the inference device 1.

In a case where it is determined that the learned-model acquisition request has been made (YES at Step S101), the accept unit 31 accepts the learned-model acquisition request at Step S102. The transmission unit 32 then transmits the learned-model acquisition request to the seller device 3 at Step S103, and the learned-model request process ends.

In a case where it is determined that the learned-model acquisition request has not been made in the accept unit 31 (NO at Step S101), the reception unit 33 determines whether the learned model has been received from the seller device 3 at Step S104. In a case where it is determined that the learned model has been received (YES at Step S104), the reception unit 33 stores the received learned model in the storage unit 40 at Step S105. The load unit 34 then loads the learned model stored in the storage unit 40 and incorporates the learnt model into an inference framework at Step S106.

In a case where it is determined that the learned model has not been received (NO at Step S104), the reception unit 33 does not perform any process, and the learned-model request process ends.

FIG. 12 is a flowchart for explaining a learned-model transmission process executed by a seller device in response to the learned-model request process in FIG. 11.

At Step S111, the accept unit 54 determines whether a learned-model acquisition request has been made by the inference device 1. In a case where it is determined that the learned-model acquisition request has been made (YES at Step S111), the accept unit 54 accepts the learned-model acquisition request at Step S112. The transmission unit 55 loads the learned model from the storage unit 60 in response to the request and transmits it to the inference device 1 at Step S113.

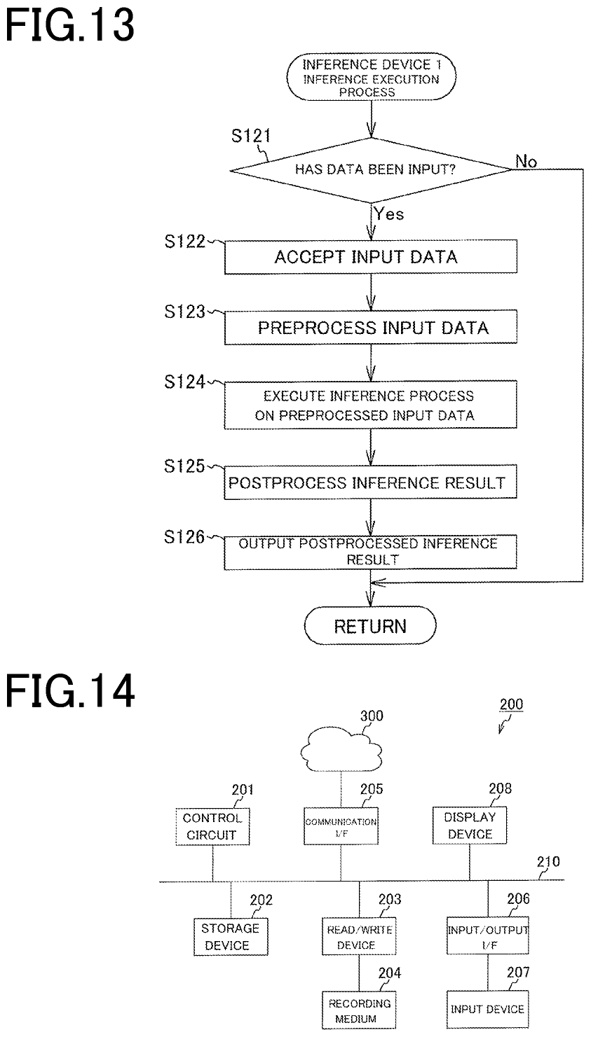

FIG. 13 is a flowchart for explaining an inference process executed by an inference device.

At Step S121, the accept unit 31 determines whether input of image data or the like that is an object of inference has been performed, that is, data has been input.

For example, input of image data can be performed by selection of image data stored in advance in the storage unit 40 by a user by using an input device such as a keyboard or a mouse provided in the inference device 1.

Alternatively, image data directly captured by an image-capturing device such as a camera provided in the inference device 1 may be input.

In a case where it is determined that data has not been input (NO at Step S121), the accept unit 31 repeats the process at Step S121. In a case where it is determined that data has been input (YES at Step S121), the accept unit 31 accepts the input data at Step S122.

At Step S123, the preprocessor 35 preprocesses the input data and stores the preprocessed input data in the storage unit 40.

Preprocessing by the preprocessor 35 is performed by execution of the bytecode 52 for preprocessing included in a learned model by the VM 12 provided in the inference framework 10.

Alternatively, preprocessing by the preprocessor 35 is performed by execution of the layer 55 for preprocessing included in a learned model by the inference engine 11 provided in the inference framework 10.

At Step S124, the inference unit 36 (the inference engine 11) executes an inference process on the preprocessed input data (converted input data) stored in the storage unit 40 and stores inference-result output data in the storage unit 40.

At Step S125, the postprocessor 37 postprocesses the inference-result output data stored in the storage unit 40 and stores the postprocessed inference-result output data in the storage unit 40.

Postprocessing by the postprocessor 37 is performed by execution of the bytecode 53 for postprocessing included in a learned model by the VM 13 provided in the inference framework 10.

Alternatively, postprocessing by the postprocessor 37 is performed by execution of the layer 56 for preprocessing included in a learned model by the inference engine 11 provided in the inference framework 10.

At Step S126, the output unit 38 outputs the postprocessed output data stored in the storage unit 40 to a subsequent application.

FIG. 14 is a block diagram illustrating an example of a computer device.

A configuration of a computer device 200 is described with reference to FIG. 14.

In FIG. 14, the computer device 200 includes a control circuit 201, a storage device 202, a read/write device 203, a recording medium 204, a communication interface 205, an input/output interface 206, an input device 207, and a display device 208. The communication interface 205 is connected to a network 300. The respective constituent elements are mutually connected via a bus 210.

Each of the seller device 3 and the inference device 1 can be configured by appropriately selecting a part or all of the constituent elements included in the computer device 200.

The control circuit 201 controls the entire computer device 200. The control circuit 201 is a processor, for example, a Central Processing Unit (CPU), a Field Programmable Gate Array (FPGA), an Application Specific Integrated Circuit (ASIC), and a Programmable Logic Device (PLD). The control circuit 201 functions as the controller 30 in FIGS. 7 and 9 or the controller 60 in FIGS. 8 and 10, for example.

The storage device 202 stores therein various types of data. The storage device 202 is, for example, a memory such as a Read-Only Memory (ROM) and a Random Access Memory (RAM) or a Hard Disk (HD). The storage device 202 may store therein an information processing program that causes the control circuit 201 to function as the controller 30 or the controller 60. The storage device 202 functions as the storage unit 40 in FIGS. 7 and 9 or the storage unit 70 in FIGS. 8 and 10, for example.

The information processing program includes at least either an inference program that causes the control circuit 201 to function as the controller 30 or a conversion program that causes the control circuit 201 to function as the controller 60.

The inference device 1 or the seller device 3 loads a program stored in the storage device 202 into a RAM when an inference process is performed.

The inference device 1 executes the program loaded into the RAM by the control circuit 201, thereby executing processing that includes at least one of an accept process, a transmission process, a reception process, a load process, a process related to preprocessing, an inference process, a process related to postprocessing, and an output process.

The seller device 3 executes the program loaded into the RAM by the control circuit 201, thereby executing processing that includes at least one of a conversion process, an integration process, an output process, an accept process, and a transmission process.

The program may be stored in a storage device provided in a server on the network 300, as long as the control circuit 201 can make access to the program via the communication interface 205.

The read/write device 203 is controlled by the control circuit 201, and reads data in the removable recording medium 204 and writes data to the removable recording medium 204.

The recording medium 204 stores therein various types of data. The recording medium 204 stores therein, for example, an information processing program. The recording medium 204 is, for example, a non-volatile memory (non-transitory computer-readable recording medium) such as a Secure Digital (SD) memory card, a Floppy Disk (FD), a Compact Disc (CD), a Digital Versatile Disk (DVD), a Blu-ray® Disk (BD), and a flash memory.

The communication interface 205 connects the computer device 200 and another device to each other via the network 300 in a communicable manner. The communication interface 205 functions as the transmission unit 32 and the reception unit 33 in FIGS. 7 and 9, for example. The communication interface 205 functions as the accept unit 64 and the transmission unit 65 in FIGS. 8 and 10.

The input/output interface 206 is, for example, an interface that can be connected to various types of input devices in a removable manner. Examples of the input device connected to the input/output interface 206 include a keyboard and a mouse. The input/output interface 206 connects each of the various types of input devices connected thereto and the computer device 200 to each other in a communicable manner. The input/output interface 206 outputs a signal input from each of the various types of input devices connected thereto to the control circuit 201 via the bus 210. The input/output interface 206 also outputs a signal output from the control circuit 201 to an input/output device via the bus 210. The input/output interface 206 functions as the accept unit 31 in FIGS. 7 and 9, for example. The input/output interface 206 also functions as the accept unit 64 in FIGS. 8 and 10, for example.

The display device 207 displays various types of information. The network 300 is, for example, a LAN, wireless communication, a P2P network, or the Internet, and connects communication between the computer device 200 and other devices.

Embodiments of the present invention are not limited to the embodiments described above, and various types of configurations and embodiments can be employed without departing from the scope of the embodiments described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. An inference system comprising a first device and a second device, wherein
the first device includes a first processor which executes processing including:
loading a learned model created by the second device, including first control information for causing the first device to perform postprocessing;
accepting input of input data of a neural network, which is an object of an inference process;
executing the inference process on the input data by using the learned model; and
performing the postprocessing that converts a data format of output data output as a result of the inference process to a format corresponding to subsequent processing in accordance with the first control information included in the learned model, and
the second device includes a second processor which executes processing including creating the learned model that includes the first control information.

2. The inference system according to claim 1, wherein the processing executed by the second processor further includes:
converting a program code of the postprocessing to a bytecode executable by the first device; and
integrating the bytecode obtained by the converting with the learned model as the first control information.

3. The inference system according to claim 2, wherein the bytecode is encrypted.

4. The inference system according to claim 1, wherein the processing executed by the second processor further includes integrating a program code of the postprocessing with the learned model as the first control information.

5. The inference system according to claim 1, wherein the processing executed by the second processor further includes:
converting a program code of the postprocessing to a layer executable by the first device; and
integrating the layer converted by the process of converting with the learned model as the first control information.

6. The inference system according to claim 1, wherein
the learned model further includes second control information for causing the first device to perform preprocessing, and
the processing executed by the first processor further includes performing the preprocessing that converts a data format of the input data accepted by the process of accepting to a format corresponding to the inference process in accordance with the second control information included in the learned model.

7. An inference device comprising a processor which executes processing including:
loading a learned model including control information for causing the inference device to perform postprocessing;
accepting input of input data of a neural network, which is an object of an inference process;
executing the inference process on the input data by using the learned model; and
performing the postprocessing that converts a data format of output data output as a result of the inference process to a format corresponding to subsequent processing in accordance with the control information included in the learned model.

8. An inference method executed by a processor of an inference device, wherein the processor
loads a learned model including control information for causing the inference device to perform postprocessing,
accepts input of input data of a neural network, which is an object of an inference process,
executes the inference process on the input data by using the learned model, and
performs the postprocessing that converts a data format of output data output as a result of the inference process to a format corresponding to processing in a subsequent in accordance with the control information included in the learned model.

9. A non-transitory computer-readable recording medium having recorded therein an inference program for causing a processor of an inference device to execute an inference process, wherein the inference process includes processing of
loading a learned model including control information for causing the inference device to perform postprocessing,
accepting input of input data of a neural network, which is an object of the inference process,
executing the inference process on the input data by using the learned model, and
performing the postprocessing that converts a data format of output data output as a result of the inference process to a format corresponding to subsequent processing in accordance with the control information included in the learned model.
